(19) United States
(12) Patent Application Publication
(10) Pub. No.: US 2017/0002230 A1
(43) Pub. Date: Jan. 5, 2017

(54) ICEPHOBIC COATINGS WITH TEMPERATURE-DEPENDENT WETTING

(71) Applicant: HRL Laboratories, LLC, Malibu, CA (US)

(72) Inventors: Andrew P. NOWAK, Los Angeles, CA (US); Adam F. GROSS, Santa Monica, CA (US)

(21) Appl. No.: 14/523,852

(22) Filed: Oct. 25, 2014

Related U.S. Application Data
(60) Provisional application No. 61/895,817, filed on Oct. 25, 2013.

(51) Int. Cl. C09D 175/04; C08K 3/26; C08K 5/544; C09D 133/14

(52) U.S. Cl. CPC C09D 175/04; C09D 133/14; C08K 3/26; C08K 5/544; C08K 2003/265

(57) ABSTRACT

Variations of this invention provide durable, impact-resistant structural coatings that have both dewetting and anti-icing properties. Dewetting and anti-icing performance is simultaneously achieved in a structural coating comprising (a) a continuous matrix; (b) discrete templates that promote surface roughness to inhibit wetting of water; (c) porous voids surrounding the discrete templates; and (d) nanoparticles that inhibit heterogeneous nucleation of water, wherein the discrete templates and/or the nanoparticles include a surface material with hydrophobicity that decreases with increasing temperature. The surface material may be a polymer brush exhibiting an upper critical solution temperature in water of 50° C. or higher. These structural coatings utilize low-cost, lightweight, and environmentally benign materials that can be rapidly sprayed over large areas using convenient coating processes. If the surface is damaged during use, freshly exposed surface will expose a coating identical to that which was removed, for extended lifetime.

### PRIORITY DATA

This patent application is a non-provisional application claiming priority to U.S. Provisional Patent App. No. 61/895,817, filed Oct. 25, 2013, which is hereby incorporated by reference herein.

### FIELD OF THE INVENTION

The present invention generally relates to durable, abrasion-resistant anti-icing coatings for various commercial applications.

### BACKGROUND OF THE INVENTION

Ice-repellent coatings can have significant impact on improving safety in many infrastructure, transportation, and cooling systems. Among numerous problems caused by icing, many are due to striking of supercooled water droplets onto a solid surface. Such icing caused by supercooled water, also known as freezing rain, atmospheric icing, or impact ice, is notorious for glazing roadways, breaking tree limbs and power lines, and stalling airfoil of aircrafts.

When supercooled water impacts surfaces, icing may occur through a heterogeneous nucleation process at the contact between water and the particles exposed on the surfaces. Icing of supercooled water on surfaces is a complex phenomenon, and it may also depend on ice adhesion, hydrodynamic conditions, the structure of the water film on the surface, and the surface energy of the surface (how well the water wets it). The mechanism of heterogeneous ice nucleation on inorganic substrates is not well understood.

Melting-point-depression fluids are well-known as a single-use approach that must be applied either just before or after icing occurs. These fluids (e.g., ethylene or propylene glycol) naturally dissipate under typical conditions of intended use (e.g. aircraft wings, roads, and windshields). These fluids do not provide extended (e.g., longer than about one hour) deicing or anti-icing. Similarly, sprayed Teflon® or fluorocarbon particles affect wetting but are removed by wiping the surface. These materials are not durable.

Chemical character of a surface is one determining factor in the hydrophobicity or contact angle that the surfaces demonstrate when exposed to water. For a smooth untextured surface, the maximum theoretical contact angle or degree of hydrophobicity possible is about 120°. Surfaces such a polytetrafluoroethylene or polydimethylsiloxane are examples of common materials that approach such contact angles.

Recent efforts for developing anti-icing or ice-phobic surfaces have been mostly devoted to utilize lotus leaf-inspired superhydrophobic surfaces. These surfaces fail in high humidity conditions, however, due to water condensation and frost formation, and even lead to increased ice adhesion due to a large surface area.

Superhydrophobicity, characterized by the high contact angle and small hysteresis of water droplets, on surfaces has been attributed to a layer of air pockets formed between water and a rough substrate. Many investigators have thus produced high contact angle surfaces through combinations of hydrophobic surface features combined with roughness or surface texture. One common method is to apply lithographic techniques to form regular features on a surface. This typically involves the creation of a series of pillars or posts that force the droplet to interact with a large area fraction of air-water interface. However, surface features such as these are not easily scalable due to the lithographic techniques used to fabricate them. Also, such surface features are susceptible to impact or abrasion during normal use. They are also single layers, which contributes to the susceptibility to abrasion.

Other investigators have produced coatings capable of freezing-point depression of water. This typically involves the use of small particles which are known to reduce freezing point. Single-layer nanoparticle coatings have been employed, but the coatings are not abrasion-resistant. Many of these coatings can actually be removed by simply wiping the surface, or through other impacts. Others have introduced melting depressants (salts or glycols) that leech out of surfaces. Once the leeching is done, the coatings do not work as anti-icing surfaces.

Nanoparticle-polymer composite coatings can provide melting-point depression and enable anti-icing, but they do not generally resist wetting of water on the surface. When water is not repelled from the surface, ice layers can still form that are difficult to remove. Even when there is some surface roughness initially, following abrasion the nanoparticles will no longer be present and the coatings will not function effectively as anti-icing surfaces.

Single layers of protrusions from coatings can show good anti-wetting behavior, but such coatings are not durable due to their inorganic structure. It was also shown recently that these structures do not control icing of surfaces Varanasi et al., “Frost formation and ice adhesion on superhydrophobic surfaces” App. Phys. Lett. 97, 234102 (2010).

There is a need in the art for scalable, durable, impact-resistant structural coatings that have both dewetting and anti-icing properties. Such coatings preferably utilize low-cost, lightweight, and environmentally benign materials that can be rapidly (minutes or hours, not days) sprayed or cast in thin layers over large areas using convenient coating processes. These structural coatings should be able to survive environments associated with aircraft and automotive applications over extended periods, for example.

There is further a need in the art for the above-described coatings that can also be conveniently cleaned. Strongly hydrophobic coatings can be difficult to effectively clean after dirt and oil accumulate on the surface and degrade the hydrophobic performance. Upon fouling from dirt or oil, a typical hydrophobic coating is difficult to clean due to the fact that the surface attracts oils and still retains the ability to partially repel water. The shedding of water on the surface limits the effectiveness of water, or a water and surfactant solution, to carry away dirt and oil.

### SUMMARY OF THE INVENTION

The present invention addresses the aforementioned needs in the art, as will now be summarized and then further described in detail below.

In some variations, the invention provides a structural coating that inhibits wetting and freezing of water, the structural coating comprising:

(a) a substantially continuous matrix comprising a hardened material;

(b) discrete templates, dispersed within the matrix, that inhibit wetting of water, wherein the discrete templates have a length scale from about 50 nanometers to about 10 microns;

(c) porous voids surrounding at least a portion of the discrete templates, wherein the porous voids have a length scale from about 50 nanometers to about 10 microns; and

(d) nanoparticles, dispersed within the matrix, that inhibit heterogeneous nucleation of water, wherein the nanoparticles have an average size of about 50 nanometers or less,

wherein the discrete templates and/or the nanoparticles include a surface material providing a surface hydrophobicity that decreases with increasing temperature.

The discrete templates do not need to be extracted or leached out of the matrix during or after synthesis. All of the templates may remain in the structural coating.

In some embodiments, the surface material has an upper critical solution temperature in water. In these embodiments, the upper critical solution temperature may be about 10° C. or higher, such as about 50° C. or higher.

In some embodiments, the surface hydrophobicity is characterized by a water contact angle that decreases by 30° or more over an increase in surface material temperature from 25° C. to 80° C. Preferably, the water contact angle decreases by 60° or more over an increase in the surface material temperature from 25° C. to 80° C.

In these or other embodiments, the surface hydrophobicity is characterized by a water contact angle that decreases to 90° or lower over an increase in surface material temperature from 25° C. to 80° C. The surface hydrophobicity may alternatively or additionally be characterized by an average water contact angle decrease with temperature of at least 0.5 degrees per degree Celsius, or at least 1.0 degrees per degree Celsius, when measured from 25° C. to 80° C.

In some embodiments of the invention, the surface material comprises a polymer brush. In these embodiments, the polymer brush preferably has an upper critical solution temperature in water. In some embodiments, the polymer brush comprises poly[2-(methacryloyloxy)ethyl]dimethyl-(3-sulfopropyl)ammonium hydroxide, or a co-polymer of at least 50 mol % of [2-(methacryloyloxy)ethyl]dimethyl-(3-sulfopropyl) ammonium hydroxide co-polymerized with another monomer.

In some embodiments, the surface material comprises a physically adsorbed polymer layer.

In some embodiments, the thickness of the structural coating is from about 50 microns to about 100 microns, or about 10 microns to about 250 microns, such as about 10, 20, 25, 30, 40, 50, 60, 70, 80, 90, 100, 150, 200, or 250 microns.

The discrete templates preferably are uniformly dispersed within the matrix. In some embodiments, the discrete templates have a length scale from about 50 nanometers to about 10 microns, such as from about 100 nanometers to about 3 microns. The discrete templates may have an average particle size from about 1 micron to about 10 microns with individual needle projections or star protrusions having an aspect ratio from about 2 to about 20, for example. In some embodiments, the structural coating has an average density of discrete templates from about 0.1 to about 0.5 g/cm³.

In some embodiments, the matrix includes porous voids surrounding at least a portion of the discrete templates, wherein the porous voids have a length scale from about 50 nanometers to about 10 microns, such as from about 100 nanometers to about 3 microns. The structural coating, in some embodiments, has a void density from about 10¹¹ to about 10¹³ voids per cm³. In various embodiments, the structural coating has a porosity from about 20% to about 70%.

In some embodiments, the nanoparticles have an average particle size from about 5 nanometers to about 50 nanometers, such as from about 10 nanometers to about 25 nanometers. At least a portion of the plurality of nanoparticles may be disposed on or adjacent to surfaces of the discrete templates. The nanoparticles may be chemically and/or physically bonded to or associated with the discrete templates.

In some embodiments, the discrete templates comprise an inorganic material selected from the group consisting of calcium carbonate, sodium chloride, sodium bromide, potassium chloride, tin (II) fluoride, iron oxides, and combinations thereof.

The nanoparticles may comprise a nanomaterial selected from the group consisting of silica, alumina, titania, zinc oxide, carbon, graphite, polytetrafluoroethylene, polystyrene, polyurethane, silicones, and combinations thereof, for example.

In some embodiments, the hardened material comprises a crosslinked polymer, such as a crosslinked polymer selected from the group consisting of polyurethanes, epoxies, acrylics, phenolic resins including urea-formaldehyde resins and phenol-formaldehyde resins, urethanes, siloxanes, and combinations thereof.

In various embodiments, the matrix further comprises one or more additives selected from the group consisting of fillers, colorants, UV absorbers, defoamers, plasticizers, viscosity modifiers, density modifiers, catalysts, and scavengers.

Some variations provide a coating precursor for a structural coating that inhibits wetting and freezing of water, the coating precursor comprising:

(a) a hardenable material capable of forming a substantially continuous matrix for a structural coating;

(b) discrete templates dispersed within the hardenable material, wherein the discrete templates have a length scale from about 50 nanometers to about 10 microns;

(c) porous voids surrounding at least a portion of the discrete templates, wherein the porous voids have a length scale from about 50 nanometers to about 10 microns; and

(d) nanoparticles dispersed within the hardenable material, wherein the nanoparticles have an average size of about 50 nanometers or less,

wherein the discrete templates and/or the nanoparticles include a surface material providing a surface hydrophobicity that decreases with increasing temperature.

Some variations provide a structural coating that inhibits wetting and freezing of water, the structural coating derived from a coating precursor; wherein the coating precursor comprises:

(a) a hardenable material capable of forming a substantially continuous matrix for a structural coating;

(b) discrete templates dispersed within the hardenable material, wherein the discrete templates have a length scale from about 50 nanometers to about 10 microns;

(c) porous voids surrounding at least a portion of the discrete templates, wherein the porous voids have a length scale from about 50 nanometers to about 10 microns; and

(d) nanoparticles dispersed within the hardenable material, wherein the nanoparticles have an average size of about 50 nanometers or less,

wherein the discrete templates and/or the nanoparticles include a surface material providing a surface hydrophobicity that decreases with increasing temperature.

### BRIEF DESCRIPTION OF THE DRAWINGS

FIG. 1A is a schematic of a structural coating, in some embodiments of the invention (a water droplet is depicted for illustration only).

FIG. 1B is a schematic of a portion of the structural coating in FIG. 1A, showing a single discrete template and nanoparticles that contain a polymer-brush surface material, according to some embodiments.

FIG. 2 is a high magnification SEM image of a structural coating according to Example 1.

FIG. 3 is a low magnification SEM image of a structural coating according to Example 1.

FIG. 4 is a cross section of a structural coating, approximately 100 μm in thickness, according to Example 1.

FIG. 5 is a cross-sectional SEM image of the Example 2 coating with temperature-responsive nanoparticles.

FIG. 6 is an SEM image of the Example 2 coating with long sharp acicular rods from the CaCO₃ component decorated with polymer-functionalized SiO₂ nanoparticles to provide temperature responsiveness.

FIG. 7 is a photographic image at room temperature of an active textured coating provided in Example 2, in comparison with the icephobic coating provided by Example 1.

FIG. 8 is a photographic image of the same samples as FIG. 7, heated to about 80° C. where the water contact angle of the active texture coating (Example 2) sample decreases dramatically while the Example 1 coating maintains contact angle.

FIG. 9 is a photographic image of the same samples as FIG. 8, cooled from 80° C. to 30° C. showing that the active textured drop (Example 2) completely wicks into the surface and evaporates. Once the temperature reaches 30° C., new water drops are placed on other locations of the surfaces to demonstrate reversibility of wetting properties with temperature for the Example 2 coating. The original and new drops are both visible on the Example 1 coating.

### DETAILED DESCRIPTION OF EMBODIMENTS OF THE INVENTION

The compositions, apparatus, systems, and methods of the present invention will be described in detail by reference to various non-limiting embodiments.

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with the accompanying drawings.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of.”

Some variations are premised on the discovery of structural coatings that simultaneously repel water and inhibit the formation of ice, with modification of the coating wetting state to a more hydrophilic one in order to enhance cleaning when exposed to warm water washes. These structural coatings possess a self-similar structure that utilizes a continuous matrix and, within the matrix, two feature sizes that are tuned to adjust the wetting of water and freezing of water on the surface that is coated. Unexpectedly, it has been discovered that the surface roughness and voids that drive high-contact-angle dewetting behavior may be created through judicious selection of template morphology, utilizing templates that do not need to be removed from the structure.

For water to freeze into ice, a water droplet must reach the surface and then remain on the surface for a time sufficient for ice nucleation and water solidification. The present invention can render it more difficult for water to remain on the surface, while increasing the time that would be necessary for water, if it does remain on the surface, to then form ice. The inventors have realized that by attacking the problem of surface ice formation using multiple length scales and multiple physical phenomena, particularly beneficial structural coatings may be fabricated.

Variations of the invention are also premised on the realization that if a surface could controllably change its wetting state with temperature, the surface could potentially be heated and rinsed effectively with water or a soap solution when the surface is in the wetting state and water will displace soil and debris on the surface. Following cleaning, the dirt-free, oil-free surface may be dried and cooled, at which time it will return to its original hydrophobic state. This addresses one of the above-mentioned challenges, i.e., a typical hydrophobic coating is difficult to clean due to the fact that the surface still retains the ability to partially repel water. The shedding of water on a conventional hydrophobic surface limits the effectiveness of water, or a water and surfactant solution, to carry away dirt and oil.

In some variations, the wetting state of the structural coating is made to be temperature-dependent through modification of one or more components (e.g., nanoparticles) to include a surface material which is characterized by a surface hydrophobicity that decreases with increasing temperature. For example, the surface material may include polymer brushes that go through an upper critical solution temperature (UCST) transition to decrease hydrophobicity with increased temperature. The surface material may be obtained or provided by a surface treatment applied to the discrete templates and/or the nanoparticles, which surface treatment imparts to the surface material the ability to decrease contact angle with increased temperature over a relevant range of temperatures.

Variations of the invention therefore can mitigate fouling of surfaces from environmental dirt and oil, which typically degrades performance while also rendering it difficult to effectively clean the surfaces due to their inherent dewetting properties. This technical problem is addressed by formation of a surface with a hydrophilicity that increases with elevated temperature and then reversibly returns to its original hydrophobic state, thereby removing contaminants from the surface and restoring optimum performance.

As used herein, an “anti-icing” (or equivalently, “icephobic”) surface or material means that the surface or material, in the presence of liquid water or water vapor, is characterized by the ability to (i) depress the freezing point of water (normally 0° C. at atmospheric pressure) and (ii) delay the onset of freezing of water at a temperature below the freezing point.

Note that in this specification, reference may be made to water “droplets” but that the invention shall not be limited to any geometry or phase of water that may be present or contemplated. Similarly, “water” does not necessarily mean pure water. Any number or type of impurities or additives may be present in water, as referenced herein.

In some variations of the present invention, an anti-icing structural coating may be designed to repel water as well as inhibit the solidification of water from a liquid phase (freezing), a gas phase (deposition), and/or an aerosol (combined freezing-deposition). Preferably, anti-icing structural coatings are capable of both inhibiting ice formation and of inhibiting wetting of water at surfaces. However, it should be recognized that in certain applications, only one of these properties may be necessary.

In some variations, the invention provides a structural coating that inhibits wetting and freezing of water, the structural coating comprising:

(a) a substantially continuous matrix comprising a hardened material;

(b) discrete templates, dispersed within the matrix, that inhibit wetting of water, wherein the discrete templates have a length scale from about 50 nanometers to about 10 microns;

(c) porous voids surrounding at least a portion of the discrete templates, wherein the porous voids have a length scale from about 50 nanometers to about 10 microns; and

(d) nanoparticles, dispersed within the matrix, that inhibit heterogeneous nucleation of water, wherein the nanoparticles have an average size of about 50 nanometers or less,

wherein the discrete templates and/or the nanoparticles include a surface material providing a surface hydrophobicity that decreases with increasing temperature.

Coating dewetting and anti-icing performance is dictated by certain combinations of structural and compositional features within the structural coating. The structural coating may be formed using, as a continuous matrix, a durable (damage-tolerant) and tough crosslinked polymer. Within the continuous matrix, there are two types of particles characterized by two different length scales in the structural coating that separately control the wetting and freezing of water on the surface.

The first type of particles is a discrete template that promotes porosity within the continuous matrix (porous voids) as well as at the surface of the coating (surface roughness). The second type of particle is a nanoparticle that inhibits heterogeneous nucleation of ice. The nanoparticles and/or discrete templates are modified, combined with another material, or otherwise treated (as described in more detail below) so that surface hydrophobicity decreases with increasing temperature.

As intended herein, a “void” or “porous void” is a discrete region of empty space, or space filled with air or another gas, that is enclosed within the continuous matrix. The voids may be open (e.g., interconnected voids) or closed (isolated within the continuous matrix, or a combination thereof. The voids may partially surround templates or nanoparticles. As intended herein, “surface roughness” means that the texture of a surface has vertical deviations that are similar to the porous voids, but not fully enclosed within the continuous matrix. In some embodiments, the size and shape of the selected discrete templates will dictate both a dimension of the porous voids as well as a roughness parameter that characterizes the surface roughness.

The discrete templates preferably have a length scale from about 50 nanometers to about 10 microns, such as from about 100 nanometers to about 3 microns. Here, a length scale refers for example to a diameter of a sphere, a height or width of a rectangle, a height or diameter of a cylinder, a length of a cube, an effective diameter of a template with arbitrary shape, and so on. For example, the discrete templates may have one or more length scales that are a distance of about 50 nm, 75 nm, 100 nm, 150 nm, 200 nm, 250 nm, 350 nm, 500 nm, 750 nm, 1 μm, 2 μm, 3 μm, 5 μm, 8 μm, or 10 μm, including any distance that is intermediate to any of the recited values.

In some embodiments, the discrete templates are dispersed uniformly in the continuous matrix. The discrete templates may be characterized as colloidal templates, in some embodiments. The discrete templates themselves may possess multiple length scales. For example, the discrete templates may have an average overall particle size as well as another length scale associated with porosity, surface area, surface layer, sub-layer, protrusions, or other physical features.

In preferred embodiments, the discrete templates are anisotropic. As meant herein, “anisotropic” templates have at least one chemical or physical property that is directionally dependent. When measured along different axes, an anisotropic template will have some variation in a measurable property. The property may be physical (e.g., geometrical) or chemical in nature, or both. The property that varies along multiple axes may simply be the presence of template mass; for example, a perfect sphere would be geometrically isotropic while a three-dimensional star shape would be anisotropic. A chemically anisotropic template may vary in composition from the surface to the bulk phase, such as via a coating, for example. The amount of variation of a chemical or physical property, measured along different axes, may be 5%, 10%, 20%, 30%, 40%, 50%, 75%, 100% or more.

In some embodiments, an anisotropic template is geometrically asymmetric in one, two, or three dimensions. As one illustration, the templates may be rectangular with an aspect (height/width) ratio of 2:1. Note that even if a template is geometrically symmetric, it still may be chemically or physically anisotropic. For example, the density of a spherical template may vary from the outer shell to the inner material.

In some embodiments, the discrete templates have an anisotropic acicular shape. “Acicular” refers to a crystal habit (external shape) characterized by a mass of slender, but rigid, needle-like crystals radiating from a central point. In some embodiments, the discrete templates have an anisotropic “scalenohedral” or star-shaped crystal habit. The acicular or scalenohedral discrete templates may have an average particle size from about 1 μm to about 10 μm with individual needle projections (or star protrusions) having an aspect ratio from about 2 to about 20, for example. In some embodiments, the discrete templates have an anisotropic prismatic shape with blades that are generally not as sharp as the needles in acicular shapes. Various other rhombohedra, tabular forms, prisms, or scalenohedra are also possible for anisotropic discrete templates, in the context of the present invention.

The discrete templates, dispersed within the continuous matrix, create porous voids. These porous voids preferably have a length scale from about 50 nanometers to about 10 microns, such as from about 100 nanometers to about 1 micron. For example, the porous voids may have one or more length scales that are a distance of about 50 nm, 75 nm, 100 nm, 150 nm, 200 nm, 250 nm, 350 nm, 500 nm, 750 nm, 0.9 μm, 0.95 μm, 1 μm, 2 μm, 3 μm, or 5 μm, including any distance that is intermediate to any of the recited values.

Typically, even when the discrete templates are all characterized by a specific geometry, the porous voids that result from the templates will be random in shape and size. Thus, the length scale of a porous void may be an effective diameter of a porous void with arbitrary shape, for example, or the minimum or maximum distance between adjacent particles, and so on.

The size of the porous voids, typically, is primarily a function of the size and shape of the discrete templates. This does not mean that the size of the voids is the same as the size of the discrete templates. The length scale of the porous void may be smaller or larger than the length scale of the discrete templates, depending on the nature of the templates, the packing density, and the method to produce the structure. In some embodiments, the average size of the porous voids is smaller than the average size of the discrete templates. For example, in certain embodiments the discrete templates have an average length scale of about 100 nm while the associated porous voids have an average length scale of about 50 nm.

The discrete templates, at a surface of the continuous matrix, create surface roughness that preferably has a length scale from about 10 nanometers to about 10 microns, such as from about 50 nanometers to about 1 micron. The length scale of surface roughness may be any number of roughness parameters known in the art, such as, but not limited to, arithmetic average of absolute deviation values, root-mean squared deviation, maximum valley depth, maximum peak height, skewness, or kurtosis. For example, the surface roughness may have one or more roughness parameters of about 10 nm, 25 nm, 50 nm, 75 nm, 100 nm, 150 nm, 200 nm, 250 nm, 350 nm, 500 nm, 750 nm, 1 μm, 2 μm, 3 μm, or 5 μm, including any distance that is intermediate to any of the recited values.

The length scale of surface roughness may be similar to the length scale of porous voids, arising from the fact that both the porous voids and the surface roughness result, at least in part, from the presence of the same discrete templates. It should also be noted, however, that the nanoparticles (with sizes as discussed below) may contribute some degree of surface roughness, independently from the contribution by the discrete templates. The surface roughness caused by the nanoparticles is typically a smaller contribution, although some of the above-recited roughness parameters may be biased more heavily by the nanoparticles.

In some embodiments, the structural coating has an average porosity of from about 20% to about 70%, such as about 40%, 45%, 50%, 55%, or 60%, as measured by mercury intrusion or another technique. In some embodiments, the structural coating has an average void density of from about 10¹¹ to about 10¹³ voids per cm³, such as about 2×10¹¹, 5×10¹¹, 8×10¹¹, 10¹², 2×10¹², 5×10¹², or 8×10¹² voids per cm³. In some embodiments, the structural coating has an average density of discrete templates of from about 0.1 to about 0.5 g/cm³, such as about 0.15, 0.2, 0.25, 0.3, 0.35, or 0.4 g/cm³.

The continuous matrix and the discrete templates are homogeneous on the length scale of roughness at the coating surface, in some embodiments. The coating surface preferably does not have substructures with high aspect ratios (normal to the surface) protruding out from the surface.

The nanoparticles within the continuous matrix preferably have a length scale from about 5 nanometers (nm) to about 50 nm, such as about 10 nm to about 25 nm. Here, a nanoparticle length scale refers for example to a diameter of a sphere, a height or width of a rectangle, a height or diameter of a cylinder, a length of a cube, an effective diameter of a nanoparticle with arbitrary shape, and so on. For example, the nanoparticles may have one or more length scales that are a distance of about 2 nm, 3 nm, 4 nm, 5 nm, 6 nm, 7 nm, 8 nm, 10 nm, 15 nm, 20 nm, 25 nm, 30 nm, 35 nm, 40 nm, 45 nm, or 50 nm, including any distance that is intermediate to any of the recited values. Generally speaking, the nanoparticles are smaller than the discrete templates.

The discrete templates are preferably dispersed uniformly within the continuous matrix. The nanoparticles may be chemically and/or physically bonded to, or otherwise associated with, the discrete templates. Alternatively, or additionally, the nanoparticles may be dispersed uniformly within the continuous matrix but not necessarily directly associated with the discrete templates. Within a porous void, the nanoparticles may be deposited on pore internal surfaces. However, nanoparticles should not be continuous across entire pores, i.e. the nanoparticles should not create an interpenetrating substructure.

Without being limited to any hypotheses, it is believed that the discrete templates, and their associated porous voids and surface roughness, inhibit water infiltration and provide an anti-wetting surface. It is believed that the nanoparticles depress the melting point of ice, i.e. lower the temperature at which water will be able to freeze. In addition, the nanoparticles may act as emulsifiers and change the matrix-air interactions to affect how the matrix (e.g., polymer) wets around the larger discrete templates. The continuous matrix offers durability, impact resistance, and abrasion resistance to the structural coating. There is homogeneity through the z-direction of the film, so that if some portion of the coating is lost (despite the resistance to abrasion), the remainder retains the ability to inhibit wetting and freezing of water.

Due to the multiple length scales and hierarchical structure that produces strong dewetting performance, the continuous matrix material and discrete templates do not necessarily need to be strongly hydrophobic. The porosity in the coating magnifies the hydrophobicity based on the Cassie-Baxter equation shown below. The nanoparticles need only be somewhat hydrophobic. This is in contrast to what is taught in the art—namely, that coating components should possess high inherent hydrophobicity. As further explained below, any individual component of the coating may have a hydrophilic character, as long as the total coating is hydrophobic (θ_{solid}>90°).

Furthermore, the coating morphology in embodiments of this invention preferably avoids single layers of high-aspect-ratio protrusions from the outer surface. Such protrusions, which are typically made from inorganic oxides, can be easily abraded by surface contact and can render the coating non-durable. In embodiments herein, the absence of such protrusions, along with the presence of a durable continuous matrix (e.g., a tough polymeric framework), gives the final coating good resistance to abrasion and impact.

In some embodiments, the structural coating offers a repeating, self-similar structure that allows the coating to be abraded during use while retaining anti-wetting and anti-icing properties. Should the surface be modified due to environmental events or influences, the self-similar nature of the structural coating allows the freshly exposed surface to present a coating identical to that which was removed.

The anti-wetting feature of the structural coating is created, at least in part, by surface roughness that increases the effective contact angle of water with the substrate as described in the Cassie-Baxter equation:

cos θ_{eff}=φ_{solid}(cos θ_{solid}+1)−1

where θ_{eff} is the effective contact angle of water, φ_{solid} is the area fraction of solid material when looking down on the surface, and θ_{solid} is the contact angle of water on a hypothetical non-porous flat surface formed from the materials in the coating. A water-air interface at the droplet surface is assumed, giving rise to the extreme contact angle of 180° associated with air (cos 180°=−1). A hydrophilic surface results when θ_{eff}<90°, whereas a hydrophobic surface results when θ_{eff}>90°. A superhydrophobic surface results when θ_{eff}≧150°.

By choosing a hydrophobic material for the coating (large θ_{solid}) and a high porosity (small φ_{solid}), the effective contact angle θ_{eff} will be maximized. Increasing the concentration of porous voids at the surface increases the contact angle θ_{eff}. It should be noted that θ_{solid} is the effective contact angle of the composite materials which include the discrete templates, nanoparticles, and continuous matrix. As a result, any individual component of the coating may have a hydrophilic character, as long as the total coating is hydrophobic (θ_{solid}>90°).

Minimization of φ_{solid} and maximization of θ_{solid} act to reduce the liquid-substrate contact area per droplet, reducing the adhesion forces holding a droplet to the surface. As a result, water droplets impacting the surface can bounce off cleanly. This property not only clears the surface of water but helps prevents the accumulation of ice in freezing conditions (including ice that may have formed homogeneously, independently from the surface). It also reduces the contact area between ice and the surface to ease removal.

In various embodiments, the effective contact angle of water θ_{eff} in the presence of a structural coating provided herein is at least 90°, such as 95°, 100°, or 105°; and preferably at least 110°, such as 115°, 120°, 125°, 130°, 135°, 140°, 145°, 150°, or higher.

The anti-icing feature of the structural coating is created, at least in part, by increasing the effective contact angle of water as described above. The anti-icing feature of the structural coating is also created, at least in part, from the incorporation of nanoparticles within the continuous matrix and, in particular, at the surface of the structural coating. As described above, nanoparticles typically in the size range of about 5-50 nm may inhibit the nucleation of ice.

In some embodiments, moderately hydrophobic, highly hydrophobic, or superhydrophobic nanoparticles reduce the melting temperature of ice (which equals the freezing temperature of water) at least some amount lower than 0° C., and as low as about −40° C. This phenomenon is known as melting-point depression (or equivalently, freezing-point depression). In various embodiments, nanoparticles reduce the melting temperature of ice at least down to −5° C., such as about −6° C., −7° C., −8° C., −9° C., −10° C., −11° C., −12° C., −13° C., −14° C., −15° C., −16° C., −17° C., −18° C., −19° C., −20° C., −21° C., −22° C., −23° C., −24° C., or −25° C., for example.

Highly textured surfaces with low liquid-substrate contact areas will slow the onset of freezing of droplets on a surface by reducing conductive heat transfer to freezing substrates. The transport of heat by conduction is reduced (slower) when there are gaps between the water droplet and the solid substrate. Also, highly textured surfaces with low liquid-substrate contact areas will reduce the rate of heterogeneous nucleation due to fewer nucleation sites. The kinetics of heterogeneous ice formation will be slowed when there are fewer nucleation sites present.

The delay of the onset of droplet freezing, or the “kinetic delay of freezing,” may be measured as the time required for a water droplet to freeze, at a given test temperature. The test temperature should be lower than 0° C., such as −5° C., −10° C., −15° C., or another temperature of interest, such as for a certain application of the coating. Even an uncoated substrate will generally have some kinetic delay of freezing. The structural coating provided herein is characterized by a longer kinetic delay of freezing than that associated with the same substrate, in uncoated form, at the same environmental conditions. This phenomenon is also the source of melting-point depression.

In various embodiments, the kinetic delay of freezing measured at about −5° C. is at least about 30 seconds, 35 seconds, 40 seconds, 50 seconds, 60 seconds, 70 seconds, 80 seconds, 81 seconds, 82 seconds, 85 seconds, 90 seconds, 100 seconds or more. In various embodiments, the kinetic delay of freezing measured at about −10° C. is at least about 30 seconds, 35 seconds, 40 seconds, 50 seconds, 60 seconds, 70 seconds, 80 seconds, 85 seconds, 90 seconds, 91 seconds, 92 seconds, 93 seconds, 95 seconds, 100 seconds, or more. In some embodiments, the kinetic delay of freezing is about 40, 45, 50, 55, 60, 65, or 70 seconds longer when the structural coating is present, compared to an uncoated substrate, measured at about −5° C. or about −10° C.

The melting-point depression and kinetic delay of freezing allow a greater chance of the liquid water to be cleared from the surface before ice formation takes place. This is especially efficacious in view of the low adhesion and anti-wetting properties (large effective contact angle) of preferred structural coatings. The problem of ice formation on surfaces has essentially been attacked using multiple length scales and multiple physical phenomena.

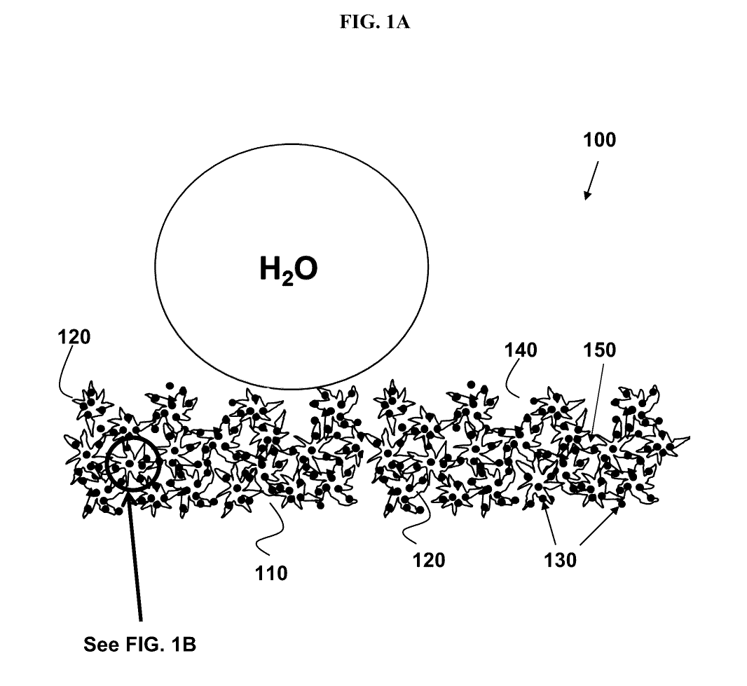

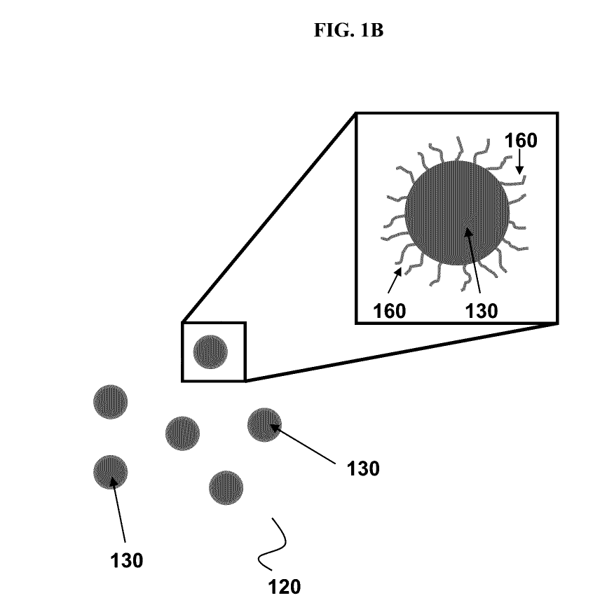

A schematic of a structural coating 100, in some embodiments, is shown in FIG. 1A. An exemplary water droplet is depicted in FIG. 1A, with the understanding that a water droplet is of course not necessarily present. The structural coating 100 includes a continuous matrix 110, discrete templates 120, and nanoparticles 130. The structural coating 100 is further characterized by surface roughness 140 and internal porous voids 150. The discrete templates 120 and/or nanoparticles 130 are treated or modified with a surface material, such as polymer brushes (see FIG. 1B), to give highly tunable anti-wetting properties.

In FIG. 1B, a portion of the structural coating (FIG. 1A) is shown, including a single discrete template 120 and nanoparticles 130 that contain a surface material of polymer brushes 160, according to some embodiments. Note that the discrete templates 120 may also contain a surface material (such as polymer brushes), in embodiments not depicted in FIG. 1B.

The “continuous matrix” (or equivalently, “substantially continuous matrix”) in the structural coating means that the matrix material is present in a form that includes chemical bonds among molecules of the matrix material. An example of such chemical bonds is crosslinking bonds between polymer chains. In a substantially continuous matrix 110, there may be present various voids (not shown in FIG. 1A, and distinct from the porous voids 150 associated with the discrete templates 120), defects, cracks, broken bonds, impurities, additives, and so on.

In some embodiments, the continuous matrix 110 comprises a crosslinked polymer. In some embodiments, the continuous matrix 110 comprises a matrix material selected from the group consisting of polyurethanes, epoxies, acrylics, urea-formaldehyde resins, phenol-formaldehyde resins, urethanes, siloxanes, ethers, esters, amides, and combinations thereof. In some embodiments, the matrix material is hydrophobic; however, the continuous matrix 110 does not require a hydrophobic matrix material.

In some embodiments, the continuous matrix 110 includes chemical bonds formed typically radical-addition reaction mechanisms with groups such as (but not limited to) acrylates, methacrylates, thiols, ethylenically unsaturated species, epoxides, or mixtures thereof. Crosslinking bonds may also be formed via reactive pairs including isocyanate/amine, isocyanate/alcohol, and epoxide/amine. Another mechanism of crosslinking may involve the addition of silyl hydrides with ethylenically unsaturated species. In addition, crosslinking bonds may be formed through condensation processes involving silyl ethers and water along with phenolic precursors and formaldehyde and/or urea and formaldehyde.

Optionally, the continuous matrix 110 may further comprise one or more additives selected from the group consisting of fillers, colorants, UV absorbers, defoamers, plasticizers, viscosity modifiers, density modifiers, catalysts, and scavengers.

The discrete templates 120 may comprise an inorganic material. For example, the inorganic material may be selected from the group consisting of calcium carbonate, sodium chloride, sodium bromide, potassium chloride, tin (II) fluoride, iron oxides (e.g., Fe₂O₃, Fe₃O₄, or FeOOH), and combinations thereof. The discrete templates 120 may be surface-modified with a compound selected from the group consisting of fatty acids, silanes, alkyl phosphonates, alkyl phosphonic acids, alkyl carboxylates, and combinations thereof.

In some embodiments, the discrete templates 120 comprise calcium carbonate (CaCO₃) particles. The calcium carbonate may be treated or sized in various ways. For example, the calcium carbonate may be modified with a fatty acid (e.g., sodium stearate) to increase hydrophobicity. The calcium carbonate may be obtained or prepared from solution, and may be milled to reduce particle size. In certain preferred embodiments, the calcium carbonate includes at least 25 wt %, at least 50 wt %, at least 75 wt %, or at least 95 wt % anisotropic calcium carbonate particles, including essentially all of the calcium carbonate being present in anisotropic form (e.g., scalenohedral or acicular).

In some embodiments, the nanoparticles 130 comprise a nanomaterial selected from the group consisting of silica, alumina, titania, zinc oxide, carbon, graphite, polytetrafluoroethylene, polystyrene, polyurethane, silicones, and combinations thereof. In certain embodiments, the nanoparticles comprise silica. Other nanoparticles 130 are possible, as will be appreciated. Optionally, the nanoparticles 130 may be surface-modified with a hydrophobic material, such as (but not limited to) silanes including an alkylsilane, a fluoroalkylsilane, and/or an alkyldisilazane (e.g., hexamethyldisilazane) as well as poly(dimethylsiloxane).

The discrete templates 120 and/or the nanoparticles 130 preferably include a surface material 160 (see FIG. 1B) providing (or characterized by) a surface hydrophobicity that decreases with increasing temperature. This surface material 160 is characterized by a decreasing water contact angle with increasing temperature.

The ability of certain materials to change their hydrophobicity with temperature is well-known. One common example is that of poly(N-isopropylacrylamide) which undergoes a lower critical solution temperature (LCST) transition in water at approximately 37° C. This transition involves the phase separation of chains and corresponding collapse of the chain volume as temperature is increased through the transition. Such phenomena are commonly used in biomedical applications to actuate events such as the delivery of drugs from a polymer in vivo or release cells from growth media.

Additionally, upper critical solution temperature (UCST) transitions are known in which a polymer material switches to a more hydrophilic state upon an increase of temperature through the transition. In simple terms, such polymers exhibit a transition that allows them to become soluble in water at higher temperatures, while tending to precipitate from solution at lower temperatures.

One such example is poly[2-(methacryloyloxy)ethyl] dimethyl(3-sulfopropyl)ammonium hydroxide (poly[MEDSAH]). Other polymers that show UCST behavior in pure water are poly(N-acryloylglycinamide), ureido-functionalized polymers, copolymers from N-vinylimidazole and 1-vinyl-2-(hydroxylmethyl)imidazole, or copolymers from acrylamide and acrylonitrile. Example of co-polymers that may be employed include 2-(methacryloyloxy)ethyl] dimethyl(3-sulfopropyl)ammonium hydroxide that is co-polymerized (in block or random fashion) with N-acryloylglycinamide, N-vinylimidazole, 1-vinyl-2-(hydroxylmethyl)imidazole, acrylamide, acrylonitrile, or other monomers. Other examples are discussed in Seuring and Agarwal, “Polymers with Upper Critical Solution Temperature in Aqueous Solution”, Macromolecular Rapid Communications, Volume 33, Issue 22, pages 1898-1920, Nov. 23, 2012 which is hereby incorporated by reference herein for its teachings of polymers exhibiting an UCST.

In some embodiments, the surface material 160 comprises a zwitterionic polymer, such as poly-3-dimethyl(methacryloyloxyethyl)ammonium propane sulfonate (PDMAPS) or poly[MEDSAH]. Some zwitterionic polymers show UCST behavior in pure water and also in salt-containing water. Reversible self-association is observed in certain polyzwitterionic hydrogels that display an UCST—that is, only at sufficiently high temperatures are the dipolar interactions broken to yield isolated polymer chains that are completely solvated.

In some embodiments, the surface material 160 (on the nanoparticles and/or the discrete templates) has an upper critical solution temperature (UCST) in water. In some embodiments, the upper critical solution temperature in water may be about 10° C., 15° C., 20° C., 25° C., 30° C., 35° C., 40° C., 45° C., 50° C., 55° C., 60° C., 65° C., 70° C., 75° C. or higher. In some embodiments, the surface material has an upper critical solution temperature in an aqueous solvent of about 10° C., 15° C., 20° C., 25° C., 30° C., 35° C., 40° C., 45° C., 50° C., 55° C., 60° C., 65° C., 70° C., 75° C. or higher. The aqueous solvent may be a water/soap solution, water containing a surfactant, or water with a polar co-solvent (such as isopropyl alcohol).

In some embodiments of the invention, the surface material 160 comprises a polymer brush, as depicted in FIG. 1B. A “polymer brush” is a layer of polymers attached with one end to a surface, to form a grafted polymer layer or tethered polymer layer. The brushes may be either in a solvent state, when the dangling chains are submerged into a solvent (such as water), or in a melt state, when the dangling chains completely fill up the space available. Polymer molecules within a brush are stretched away from the attachment surface since they repel each other (steric repulsion or osmotic pressure).

In these embodiments, the polymer brush preferably has an upper critical solution temperature in water. In some embodiments, the polymer brush comprises poly[2-(methacryloyloxy)ethyl]dimethyl-(3-sulfopropyl)ammonium hydroxide, or a co-polymer of at least 10, 20, 30, 40, or 50 mol % of [2-(methacryloyloxy)ethyl]dimethyl-(3-sulfopropyl)ammonium hydroxide or more, co-polymerized with another monomer.

In some embodiments, 5-50 nm diameter nanoparticles have a polymer brush containing poly[MEDSAH] grown from their surfaces (according to FIG. 1B) that is sensitive to temperature and increases hydrophilicity, with increasing temperature, of the particles as well as of the overall composite coatings. In certain embodiments, a polymer brush containing poly[MEDSAH] is also grown from at least a portion of the discrete template surfaces.

In some embodiments, atom transfer radical polymerization (ATRP) is utilized to grow polymer brushes from the nanoparticles or discrete templates. Surface-initiated polymerizations can produce surface-grafted polymers including copolymers and block copolymers. As this polymerization is “living”, it is possible to gain control over the thickness and composition of the polymer films or brushes.

In some embodiments, the surface material comprises a physically adsorbed polymer layer, rather than (or in addition to) a covalently linked polymer chain. Polymer molecules in physically adsorbed polymer layers may be stretched away from the surface since they repel each other (steric repulsion or osmotic pressure).

This disclosure hereby incorporates by reference Shulz et al., “Phase Behavior and Solution Properties of Sulphobetaine Polymers,” Polymer (1986) 27 1734-1742, for its teachings regarding basic solution properties and association behavior of polymer brushes that may be employed in embodiments of this invention.

This disclosure hereby incorporates by reference Azzaroni et al., “UCST Wetting Transitions of Polyzwitterionic Brushes Driven by Self-Association,” AngewandteChemie (2006) 118 1802-1806, for its description of the growth of a polymer brush from a flat surface of Si, as may be employed in embodiments of this invention. Wetting of water on surfaces was measured by Azzaroni et al. as a function of brush height and temperature. The UCST transition temperature was found to be between 40-50° C. and the advancing contact angle moved from 90° to −30° with increasing temperature while being shown to be reversible.

This disclosure hereby incorporates by reference Husseman et al., “Controlled Synthesis of Polymer Brushes by “Living” Free Radical Polymerization Techniques,” Macromolecules (1999) 32 1424-1431, for its description of synthesis of atom transfer radical polymerization initiator silane species used to graft onto SiO₂ nanoparticles as may be employed in embodiments of this invention.

This disclosure hereby incorporates by reference Pyun et al., “Synthesis and Characterization of Organic/Inorganic Hybrid Nanoparticles: Kinetics of Surface-Initiated Atom Transfer Radical Polymerization and Morphology of Hybrid Nanoparticle Ultrathin Films,” Macromolecules (2003) 36 5094-5104 for its teachings of techniques for modification of colloidal silica nanoparticles with atom transfer radical polymerization initiators and the subsequent growth of polymer chains from their surfaces.

This disclosure hereby incorporates by reference Roy et al., “New Directions in Thermoresponsive Polymers,” Chem. Soc. Rev., 2013, 42, 7214, for its description of various thermoresponsive polymers, such as polymers exhibiting an UCST including poly(N-isopropylacrylamide)-b-poly[3-(N-(3-methacrylamidopropyl)-N,N-dimethyl)ammoniopropane sulfonate], poly(N-acryloylglycinamide), poly(N-acryloylasparaginamide), poly(acrylonitrile-co-acrylamide), and poly(methacrylamide).

UCST transitions are not necessarily limited to polymers; for example, certain ionic liquids display UCST transitions. Also, while brush morphologies will typically be polymeric to enable viable grafting of the brush molecules on the surface, it should be recognized a layer of non-polymer surface material may also provide a surface hydrophobicity that decreases with increasing temperature.

In some embodiments, the surface hydrophobicity is characterized by a water contact angle that decreases by 10°, 20°, 30°, 40°, 50°, 60°, 70°, 80°, 90° or more over an increase in surface material temperature from 25° C. to 80° C. Preferably, the water contact angle decreases by 60° or more over an increase in the surface material temperature from 25° C. to 80° C.

In some embodiments, the surface hydrophobicity is characterized by a water contact angle that decreases by 10°, 20°, 30°, 40°, 50°, 60°, or more over an increase in surface material temperature from 20° C. to 100° C., from 40° C. to 70° C., from 25° C. to 50° C., from 30° C. to 70° C., or any other span of temperature within 20° C. to 100° C.

In these or other embodiments, the surface hydrophobicity is characterized by a water contact angle that decreases to 90° or lower over an increase in surface material temperature from 25° C. to 80° C. For example, the surface hydrophobicity may be characterized by a water contact angle that decreases to about 90°, 80°, 70°, 60°, 50°, 40°, 30°, 20°, 10°, or 5° at a temperature of about 40° C., 45° C., 50° C., 55° C., 60° C., 65° C., 70° C., 75° C., or 80° C.

The surface hydrophobicity may alternatively or additionally be characterized by an average water contact angle decrease with temperature of at least about 0.5, 0.6, 0.7, 0.8, 0.9, 1.0, 1.1, 1.2, 1.3, 1.4, 1.5, 1.6, 1.7, 1.8, 1.9, or 2.0 degrees per degree Celsius (°/° C.) or higher, when measured starting from 25° C. up to 80° C.

The surface hydrophobicity may alternatively or additionally be characterized by an instantaneous water contact angle decrease with temperature of at least about 0.5, 1.0, 1.5, 2.0, 2.5, or 3.0 degrees per degree Celsius (°/° C.) or higher, when measured at a specific temperature that falls in the range of 25° C. to 80° C.

The water contact angle associated with the surface material is not necessarily the same as the effective contact angle of water θ_{eff} described previously. In some embodiments, the effective contact angle of water θ_{eff} is dominated by the water contact angle associated with the nanoparticle and/or discrete template surface material, so that the latter water contact angles are substantially the same as the measured θ_{eff} for the total structural coating.

In other embodiments, due to the matrix material and the fact that one of the nanoparticles and discrete templates might not include the temperature-dependent surface material, the effective contact angle of water θ_{eff} for the total structural coating may be lower or higher than the water contact angle associated with the surface material (e.g., polymer brushes).

The thickness of the temperature-dependent surface material layer (which is the thickness of the polymer brush, when the surface material is a polymer brush) may vary. For example, the thickness of the temperature-dependent surface material may be from about 1 nm to 1 μm or more, such as about 2 nm, 5 nm, 10 nm, 20 nm, 50 nm, 75 nm, 100 nm, 200 nm, 400 nm, 500 nm, 750 nm, 1 μm, or higher.

A wide range of concentrations of components may be present in the structural coating. For example, the continuous matrix may be from about 5 wt % to about 95 wt %, such as from about 10 wt % to about 40 wt % of the structural coating. The discrete templates (and the temperature-dependent surface material, if present) may be from about 1 wt % to about 90 wt %, such as from about 50 wt % to about 80 wt % of the structural coating. The nanoparticles (and the temperature-dependent surface material, if present) may be from about 0.1 wt % to about 25 wt %, such as from about 1 wt % to about 10 wt % of the structural coating.

In certain embodiments, the structural coating includes about 5 wt % to 80 wt % discrete templates and about 0.5 wt % to 10 wt % nanoparticles in about 15 wt % to about 90 wt % of a continuous matrix, such as about 50-70 wt % discrete templates and about 4-8 wt % nanoparticles in about 15-25 wt % of a continuous matrix.

The temperature-dependent surface material, in various embodiments, may be present from about 0.5 wt % to about 50 wt %, such as about 5 wt % to about 25 wt %, of the nanoparticles, the discrete templates, or the nanoparticles and discrete templates on a combined weight basis. The temperature-dependent surface material, in various embodiments, may be present from about 0.1 wt % to about 20 wt %, such as about 2 wt % to about 10 wt %, of the total structural coating.

Any known methods to fabricate these structural coatings may be employed. Notably, these structural coatings may utilize synthesis methods that enable simultaneous deposition of components to reduce fabrication cost and time. In particular, these coatings may be formed by a one-step process, in some embodiments. In other embodiments, these coatings may be formed by a multiple-step process.

In some embodiments, a coating precursor is prepared and then dispensed (deposited) over an area of interest. Any known methods to deposit coating precursors may be employed. The fluid nature of the coating precursor allows for convenient dispensing using spray coating or casting techniques over a large area, such as the scale of a vehicle or aircraft.

In some variations, a coating precursor comprises:

(a) a hardenable material capable of forming a substantially continuous matrix for a structural coating;

(b) a plurality of discrete templates dispersed (preferably in a uniform fashion) within the hardenable material; and

(c) a plurality of nanoparticles with an average size of about 50 nanometers or less dispersed within the hardenable material,

wherein the discrete templates and/or the nanoparticles include a surface material providing a surface hydrophobicity that decreases with increasing temperature.

Some variations provide a coating precursor for a structural coating that inhibits wetting and freezing of water, the coating precursor comprising:

(a) a hardenable material capable of forming a substantially continuous matrix for a structural coating;

(b) discrete templates dispersed within the hardenable material, wherein the discrete templates have a length scale from about 50 nanometers to about 10 microns;

(c) porous voids surrounding at least a portion of the discrete templates, wherein the porous voids have a length scale from about 50 nanometers to about 10 microns; and

(d) nanoparticles dispersed within the hardenable material, wherein the nanoparticles have an average size of about 50 nanometers or less,

wherein the discrete templates and/or the nanoparticles include a surface material providing a surface hydrophobicity that decreases with increasing temperature.

Some variations provide a structural coating that inhibits wetting and freezing of water, the structural coating derived from a coating precursor; wherein the coating precursor comprises:

(a) a hardenable material capable of forming a substantially continuous matrix for a structural coating;

(b) discrete templates dispersed within the hardenable material, wherein the discrete templates have a length scale from about 50 nanometers to about 10 microns;

(c) porous voids surrounding at least a portion of the discrete templates, wherein the porous voids have a length scale from about 50 nanometers to about 10 microns; and

(d) nanoparticles dispersed within the hardenable material, wherein the nanoparticles have an average size of about 50 nanometers or less,

wherein the discrete templates and/or the nanoparticles include a surface material providing a surface hydrophobicity that decreases with increasing temperature.

The hardenable material may be any organic oligomeric or polymeric mixture that is capable of being hardened or cured (crosslinked). The hardenable material may be dissolved in a solvent to form a solution, or suspended in a carrier fluid to form a suspension, or both of these. The hardenable material may include low-molecular-weight components with reactive groups that subsequently react (using heat, radiation, catalysts, initiators, or any combination thereof) to form a continuous three-dimensional network as the continuous matrix. This network may include crosslinked chemicals (e.g. polymers), or other hardened material (e.g., precipitated compounds).

Discrete templates and nanoparticles are dispersed with the hardenable material. The discrete templates and nanoparticles are preferably not dissolved in the hardenable material, i.e., they should remain as discrete components in the final structural coating. In some embodiments, the discrete templates and/or nanoparticles may dissolve into the hardenable material phase but then precipitate back out of the material as it is curing, so that in the final structural coating, the discrete templates and/or nanoparticles are distinct (e.g., as in FIGS. 1A and 1B).

Thus in some embodiments, a process for fabricating a structural coating includes preparing a hardenable material, introducing discrete templates and nanoparticles into the hardenable material to form a fluid mixture (solution or suspension), applying the fluid mixture to a selected surface, and allowing the fluid mixture to cure to form a solid. This process is optionally repeated to form multiple layers, resulting in the structural coating. The hardenable material is essentially the precursor to the continuous matrix, i.e. the hardened or cured form of the hardenable material is the continuous matrix of the structural coating. The porous voids and surface roughness in the coating may form as part of the curing or hardening process.

In some embodiments, the hardenable material is a crosslinkable polymer selected from the group consisting of polyurethanes, epoxies, acrylics, urea-formaldehyde resins, phenol-formaldehyde resins, urethanes, siloxanes, ethers, esters, amides, and combinations thereof. The hardenable material may be combined with one or more additives selected from the group consisting of fillers, colorants, UV absorbers, defoamers, plasticizers, viscosity modifiers, density modifiers, catalysts, and scavengers.

The fluid mixture may be applied to a surface using any coating technique, such as (but not limited to) spray coating, dip coating, doctor-blade coating, spin coating, air knife coating, curtain coating, single and multilayer slide coating, gap coating, knife-over-roll coating, metering rod (Meyer bar) coating, reverse roll coating, rotary screen coating, extrusion coating, casting, or printing. Because relatively simple coating processes may be employed, rather than lithography or vacuum-based techniques, the fluid mixture may be rapidly sprayed or cast in thin layers over large areas (such as multiple square meters).

When a solvent is present in the fluid mixture, the solvent may include one or more compounds selected from the group consisting of water, alcohols (such as methanol, ethanol, isopropanol, or tert-butanol), ketones (such as acetone, methyl ethyl ketone, or methyl isobutyl ketone), hydrocarbons (e.g., toluene), acetates (such as tert-butyl acetate), organic acids, and any mixtures thereof. When a solvent is present, it may be in a concentration of from about 10 wt % to about 99 wt % or higher, for example. An effective amount of solvent is an amount of solvent that dissolves at least 95% of the hardenable material present. Preferably, a solvent does not adversely impact the formation of the hardened (e.g., crosslinked) network and does not dissolve/swell the discrete templates or nanoparticles.

When a carrier fluid is present in the fluid mixture, the carrier fluid may include one or more compounds selected from the group consisting of water, alcohols, ketones, acetates, hydrocarbons, acids, bases, and any mixtures thereof. When a carrier fluid is present, it may be in a concentration of from about 10 wt % to about 99 wt % or higher, for example. An effective amount of carrier fluid is an amount of carrier fluid that suspends at least 95% of the hardenable material present. A carrier fluid may also be a solvent, or may be in addition to a solvent, or may be used solely to suspend but not dissolve the hardenable material. A carrier fluid may be selected to suspend the discrete templates and/or nanoparticles in conjunction with a solvent for dissolving the hardenable material, in some embodiments.

A wide range of concentrations of components may be present in the coating precursor. For example, the hardenable material may be from about 5 wt % to about 90 wt %, such as from about 10 wt % to about 40 wt % of the coating precursor on a solvent-free and carrier fluid-free basis. The discrete templates may be from about 1 wt % to about 90 wt %, such as from about 50 wt % to about 80 wt % of the coating precursor on a solvent-free and carrier fluid-free basis. The nanoparticles may be from about 0.1 wt % to about 25 wt %, such as from about 1 wt % to about 10 wt % of the coating precursor on a solvent-free and carrier fluid-free basis. In certain embodiments, the coating precursor includes about 70-80 wt % discrete templates and about 4-8 wt % nanoparticles in about 15-25 wt % of a hardenable material, such as about 74 wt % discrete templates and about 6 wt % nanoparticles in about 20 wt % of a hardenable material, on a solvent-free and carrier fluid-free basis. In various embodiments, the coating precursor includes about 50-90 wt % of a hardenable material, about 0.5-10 wt % nanoparticles, and about 5-50 wt % discrete templates.

The structural coating that is produced at least from hardening the coating precursor is a self-similar, multi-scale structure with good abrasion resistance. The self-similar material means that following impact or abrasion of the coating, which may remove or damage a layer, there will be more coating material that presents the same functionality. Additional layers that do not include one or more of the continuous matrix, discrete templates, and nanoparticles may be present. Such additional layers may be underlying base layers, additive layers, or ornamental layers (e.g., coloring layers).

The overall thickness of the structural coating may be from about 1 μm to about 1 cm or more, such as about 10 μm, 20 μm, 25 μm, 30 μm, 40 μm, 50 μm, 75 μm, 100 μm, 500 μm, 1 mm, 1 cm, or 10 cm. Relatively thick coatings offer good durability and mechanical properties, such as impact resistance, while preferably being relatively lightweight. In preferred embodiments, the coating thickness is about 5 μm to about 500 μm, such as about 50 μm to about 100 μm.

In some embodiments, the thickness of the structural coating is from about 50 microns to about 100 microns, or about 10 microns to about 250 microns, such as about 10, 20, 30, 40, 50, 60, 70, 80, 90, 100, 150, 200, or 250 microns. Other coating thicknesses are possible as well.

### Example 1

This Example 1 demonstrates an anti-icing structural coating.

Bahydrol® 2770 (polyurethane), Bahydrol® 2058 (polyurethane), and Bayhydur® 2655 (polyisocyanate) are obtained from Bayer Materials Science (Pittsburgh, Pa., US). Hexamethyldisilazane (HMDZ)-treated silica is a product of Gelest (Morrisville, Pa., US). Precipitated Calcium Carbonate (Magnum Fill H097) is a product of Mississippi Lime (St. Louis, Mo., US). All items are used as received without further purification. Spray coating is carried out using an Ampro A6034 low-volume, low-pressure spray gun.

Bahydrol 2770 (1 g), Bahydrol 2058 (0.16 g), and Bayhydur 2655 (0.5 g) are weighed out and combined into a 50 mL centrifuge tube. Following this, HMDZ-treated silica (0.5 g) is added to the container along with precipitated calcium carbonate (6 g, Magnum Fill HO97). Finally, deionized water (10 g) is added, and the tube is capped and agitated vigorously for 1 minute. At this point the mixture shows a thick creamy homogenous consistency. If any aggregates are visible, agitation is continued until the mixture is smooth.

Next, additional deionized water (20 g) is added to thin the mixture and the solution is blended with a high-speed mixer (Omni Mixer Homogenizer) for 5 minutes. The fluid solution is then transferred to a handheld sprayer and applied to aluminum panels. The full coating precursor is deposited by coating the entire panel in layers and waiting for 15 minutes between coats until the desired coating thickness is achieved. The material is cured, thereby converting the coating precursor into the structural coating.

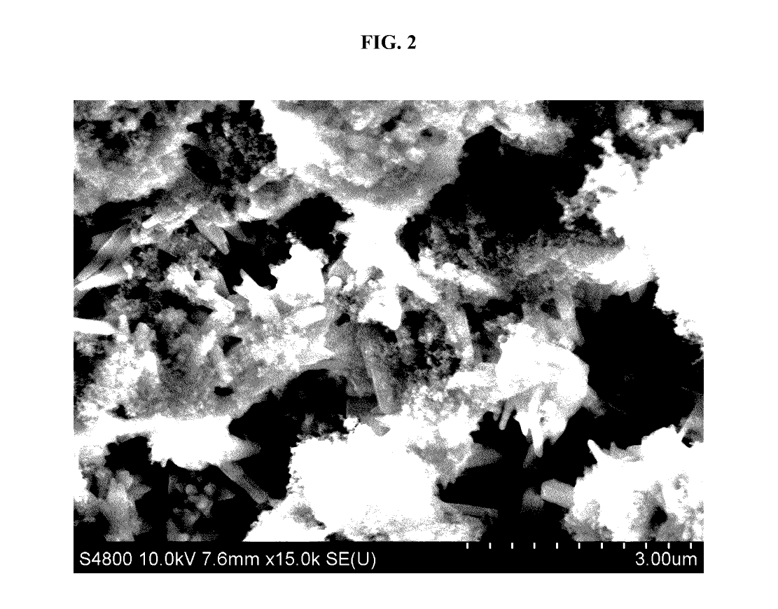

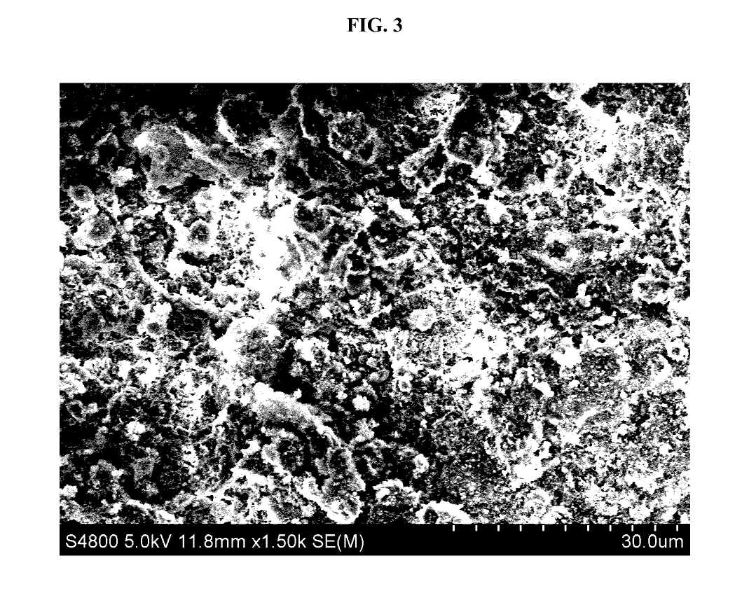

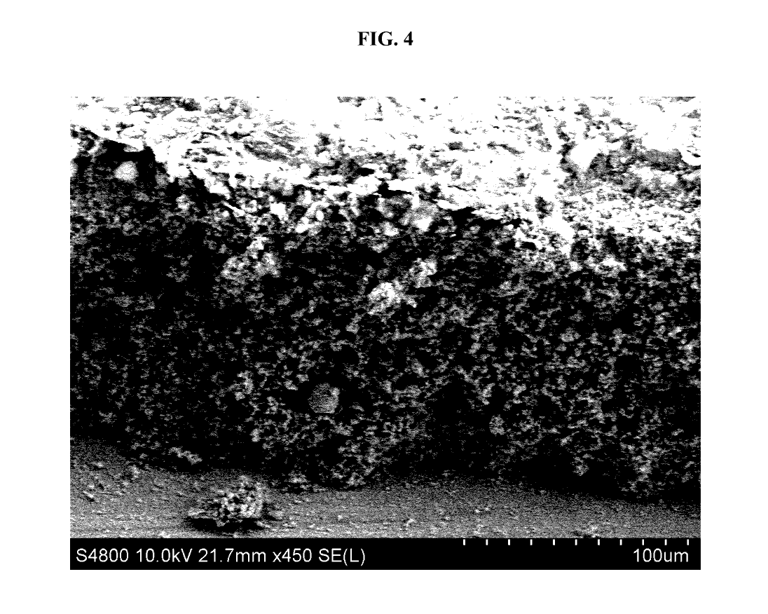

FIGS. 2 and 3 show surface images (scanning electron microscope, SEM) following spray coating and curing. In FIG. 2, a high magnification SEM image shows the composite structure with anisotropic micron-sized CaCO₃ templates, silazane-treated silica nanoparticles, and a continuous polymeric matrix binding the two together along with micron-sized voids creating a rough textured surface. In FIG. 3, a low magnification SEM image shows the homogeneity of the structure over longer length scales as well as the longer length scales of surface roughness. FIG. 4 shows a cross section of the structural coating, approximately 100 μm in thickness. Self similarity and porosity extending through the thickness of the coating are evident.

This structural coating is subjected to a freezing-point depression measurement. It is found that the freezing of a water droplet on this coating, cooled by a thermoelectric cooler, occurs at −14° C.±1° C. under atmospheric pressure, rather than at 0° C.

### Example 2

This Example 2 demonstrates an anti-icing coating with temperature-responsive nanoparticles.

2-Bromo-2-methylpropionyl bromide (17.25 g, 75 mmole) is placed in a small dropping funnel and attached to a 100 mL round bottom flask charged with methylene chloride (40 mL, 53 g) that has been dried over 4 Å molecular sieves. Additionally (7.5 g, 75 mmole) of 5-hexen-7-ol is added along with triethylamine (9.05 g, 90 mmole) dried over 4 Å molecular sieves.

The round bottom flask is placed in an ice bath and the bromide slowly dropped into the solution over the course of one hour. Then the ice bath is removed and the reaction stirred for two hours at room temperature. Triethylamine hydrochloride salt is removed through the use of a Büchner funnel. The product of filtration is washed once with saturated NH₄Cl and twice with DI H₂O. The crude product is concentrated under vacuum and then vacuum distilled.

Next 0.9 g of the distilled product is added to 15 mL trichlorosilane and 2.5 mL of a 6 mg/mL solution of H₂PtCl₆ in tetrahydrofuran. The solution is purged with N₂, protected from light, and stirred overnight in which it becomes homogeneous. The next day dry toluene (5 mL, 4 Å sieves) is added and excess trichlorosilane removed under vacuum. Dry CH₂Cl₂ (15 mL, 4 Å sieves) is then added and pumped off. This is repeated once more before the solution is covered and stored in a 4° C. refrigerator.

The 5 mL of the trichlorosilane initiator in toluene described above (0.75 g Br initiator, 3.2 mmole) is added to 5 g of colloidal SiO₂ in methyl isobutyl ketone (MIBK-ST 40%, Nisaan). After refluxing overnight hexamethyldisilazane (0.6 mL) is added and the solution refluxed for 6 additional hours. This yields a yellow turbid suspension that is centrifuged and dried to recover the product as an off-white powder.

15 g of poly[2-(methacryloyloxy)ethyl] dimethyl(3-sulfopropyl) ammonium hydroxide (MEDSAH) is charged to a 100 mL flat bottom flask and methanol (50 mL) is added with agitation until the MEDSAH is completely dissolved before purging with N₂ for 30 min. Next the initiator solution is prepared by adding N,N′-bipyridyl to a 5 mL solution of methanol/H₂O at 80/20 w/w. CuCl (106 mg) and CuCl₂ (14.5 mg) are then weighed out and charged to the vial before purging with N₂ for 15 minutes. During this time 30 mL of the degassed MEDSAH solution is transferred via syringe to a Schlenk flask that has been charged with 500 mg of the functionalized SiO₂ described above. The solution in the flask is sonicated and vortexed to better disperse the solids. After 15 min, 2.5 mL of the initiator solution is injected via syringe. The solution is left to react for 72 hours at which time it is exposed to air and a significant precipitate is found at the bottom of the flask.

The crude product is extracted with multiple aliquots of water (40 mL) heated to approximately 60° C. These are combined and dialyzed overnight before lyophilization recovers solid material. The solution is resuspended and spun down to concentrate SiO₂ powder on the bottom and better separate any free MEDSAH homopolymer in solution. This is repeated two times.

The product is then frozen and lyophilized to recover 0.5 g of material, which consists essentially of MEDSAH-functionalized nanoparticles. This is then worked up in an identical fashion to Example 1 except HMDZ-treated silica is replaced here with the MEDSAH-functionalized nanoparticles.

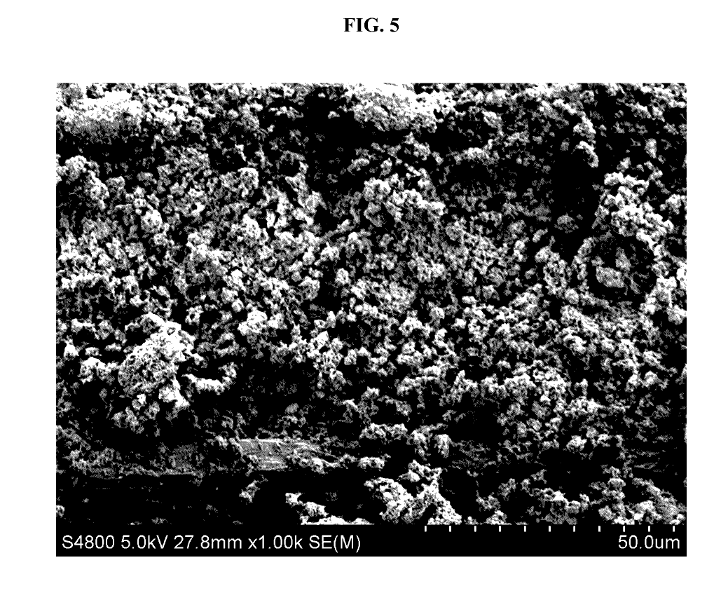

FIG. 5 shows a cross-sectional SEM view of the Example 2 coating with temperature-responsive nanoparticles. The coating thickness is approximately 50 μm. The self-similar structure perpendicular to the surface is evident.

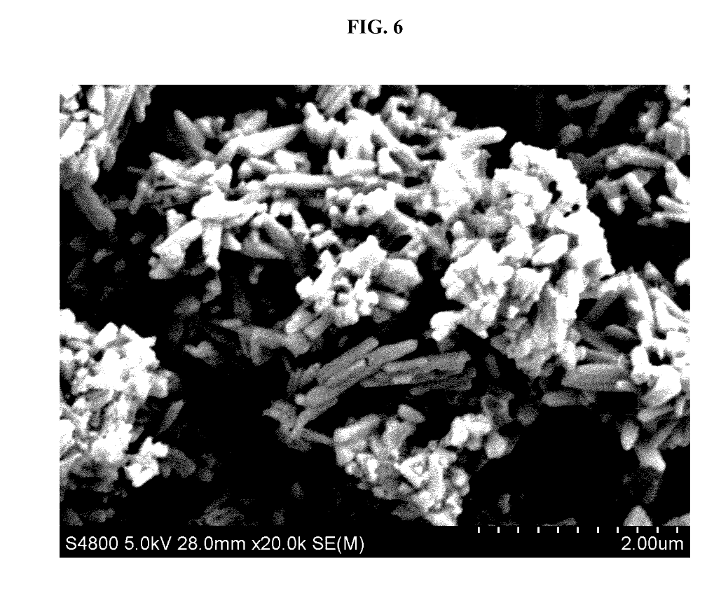

FIG. 6 shows increased SEM magnification of the Example 2 coating with long sharp acicular rods from the CaCO₃ component decorated with polymer-functionalized SiO₂ nanoparticles to provide temperature responsiveness.

Table 1 below shows contact angle wetting data with temperature cycling where the initial wetting angle is measured and the surface is then heated to 80° C. Upon heating, the surface becomes hydrophilic to the point that much of the water wicks into the surface and evaporates. The coating is then cooled to room temperature, a fresh drop is placed on the surface and the contact angle is measured again, showing that the measured contact angle is about the same as the initial contact angle prior to heating.

TABLE 1
Temperature Dependent Wetting Behavior

| Temperature | Contact Angle |
|---|---|
| Room Temp (~25° C.) | 107° |
| 80° C. (Heated) | 5° |
| Room Temp (Cooled) | 105° |

Table 2 below shows contact angle measured for an initial sample of the Example 2 coating as well as samples placed on a roof to be exposed to the elements for 22 days. Following this time, the coating contact angle is remeasured and then washed with both warm water (70° C.) and ambient temperature water (20° C.), demonstrating recovery of hydrophobic properties with solely the warm water wash.

TABLE 2
Recoverable Wetting with Cleaning
Following Environmental Exposure

| | Contact |
|---|---|
| Coating | Angle |
| Initial | 107° |
| Environmental Exposure, | 87° |
| 22 Days | |
| Cleaned, 70° C. Water Wash | 116° |
| Cleaned, 20° C. Water Wash | 87° |

Wetting behavior upon exposure to the elements is tested following a 22-day exposure on the roof. Freezing delay is measured (n=3) and the coating is cleaned with hot water and left to dry before remeasuring the freezing delay.

TABLE 3
Freezing Delay
Upon Environmental
Exposure

| | Freezing |
|---|---|
| | Delay |
| Coating | (seconds) |
| Dirty, 22 Days | 33.3 ± 1.2 |
| Exposure | |
| Cleaned | 52.5 ± 0.6 |

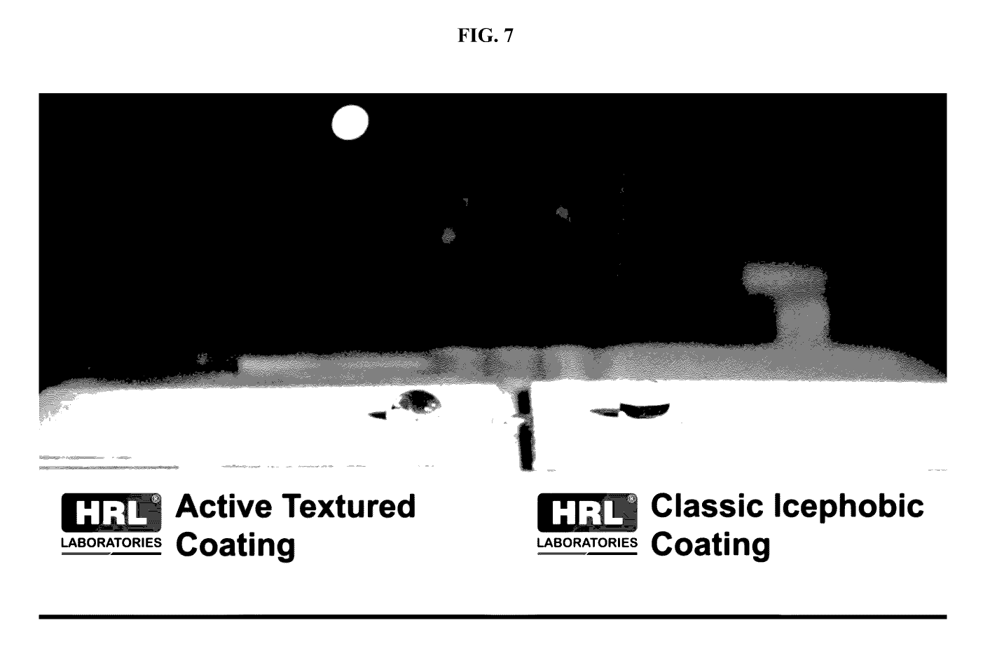

FIG. 7 shows a photographic image of an active textured coating provided in this Example 2, in comparison with the icephobic coating provided by Example 1. Water droplets are placed on the surface and imaged before heating to a temperature of about 30° C.

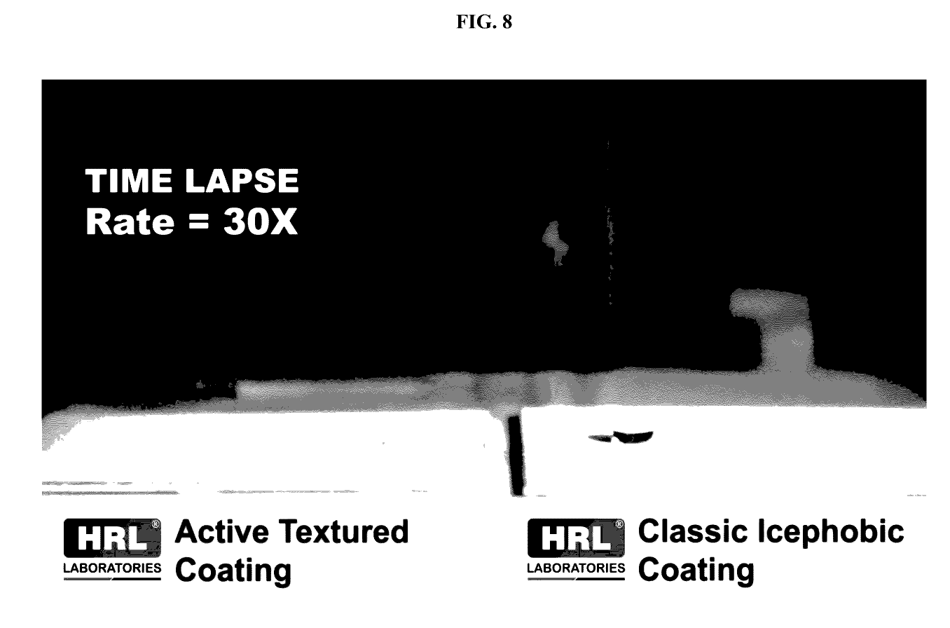

As depicted in the photographic image of FIG. 8, the same samples are then heated to about 80° C. where the water contact angle of the active texture coating (Example 2) sample decreases dramatically while the Example 1 coating maintains contact angle. During this time, water from the active textured drop (Example 2) is observed wicking into the coating and evaporating from the surface temperature, while the Example 1 coating loses some mass due to evaporation but maintains a high contact angle.

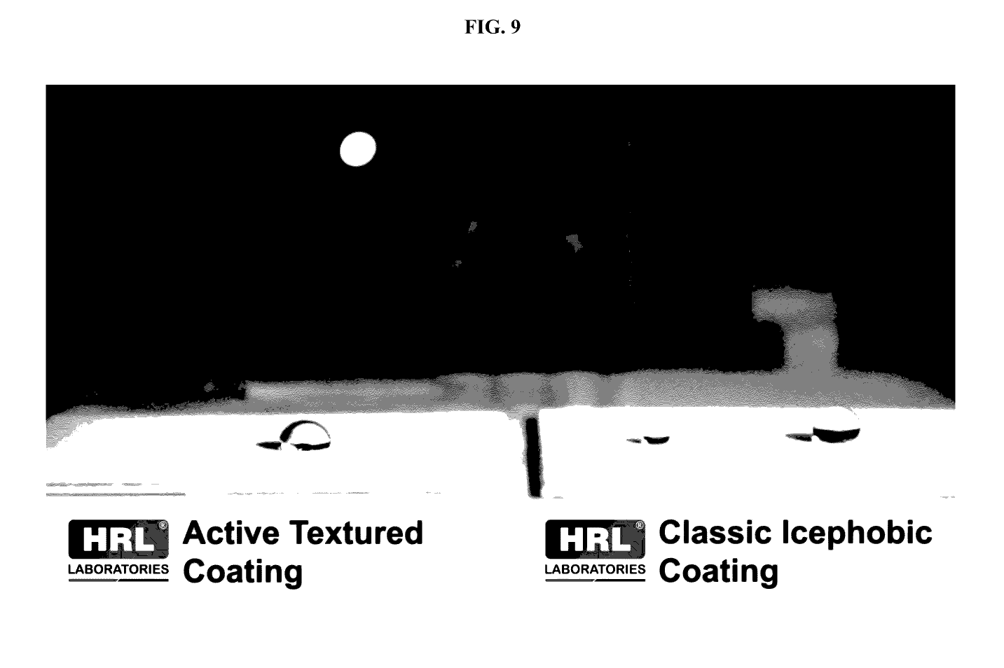

As depicted in the photographic image of FIG. 9, the same samples are then cooled from 80° C. to 30° C. showing that the active textured drop (Example 2) completely wicks into the surface and evaporates. A small original drop from the Example 1 coating is still present after the cycle. Once the temperature has stabilized at 30° C., water drops are placed on the surfaces again to demonstrate reversibility of wetting properties with temperature for the Example 2 coating. The original and new drops are both visible on the Example 1 coating.

This Example 2 demonstrates that a coating surface may controllably change its wetting state with temperature and the surface may be heated and rinsed effectively with water or a soap solution when the surface is in the wetting state. Following cleaning, the dirt- and oil-free surface may be dried and cooled upon which time it returns to its original hydrophobic state.

The invention disclosed has various commercial and industrial applications. Aerospace applications involve anti-icing coatings for both passenger and unmanned aerial vehicles. Automotive applications include coatings that help reduce ice buildup on moving external parts such as louvers, coatings for car grills, and coatings for protecting radiators or heat exchangers from ice build-up. Strongly anti-wetting surfaces also have the benefit of rapidly removing dirt and debris when flushed with water for a self-cleaning property that could be of benefit to multiple automotive surfaces.

Other applications include, but are not limited to, refrigeration, roofs, wires, outdoor signs, marine vessels, power lines, wind turbines, oil and gas drilling equipment, telecommunications equipment, as well as in many commercial and residential refrigerators and freezers. The principles taught herein may be applied to self-cleaning materials, anti-adhesive coatings, corrosion-free coatings, etc.

In this detailed description, reference has been made to multiple embodiments and to the accompanying drawings in which are shown by way of illustration specific exemplary embodiments of the invention. These embodiments are described in sufficient detail to enable those skilled in the art to practice the invention, and it is to be understood that modifications to the various disclosed embodiments may be made by a skilled artisan.

Where methods and steps described above indicate certain events occurring in certain order, those of ordinary skill in the art will recognize that the ordering of certain steps may be modified and that such modifications are in accordance with the variations of the invention. Additionally, certain steps may be performed concurrently in a parallel process when possible, as well as performed sequentially. All publications, patents, and patent applications cited in this specification are herein incorporated by reference in their entirety as if each publication, patent, or patent application were specifically and individually put forth herein. U.S. patent application Ser. No. 13/708,642, filed Dec. 7, 2012, is also hereby incorporated by reference herein in its entirety.

The embodiments, variations, and figures described above should provide an indication of the utility and versatility of the present invention. Other embodiments that do not provide all of the features and advantages set forth herein may also be utilized, without departing from the spirit and scope of the present invention. Such modifications and variations are considered to be within the scope of the invention defined by the claims.

1. A structural coating that inhibits wetting and freezing of water, said structural coating comprising a plurality of layers, wherein each layer includes:
(a) a substantially continuous matrix comprising a hardened material;
(b) discrete templates, dispersed uniformly within said matrix, that inhibit wetting of water, wherein said discrete templates have an average template length scale from about 50 nanometers to about 10 microns, wherein said discrete templates promote surface roughness at a surface of said layer, and wherein said surface roughness inhibits wetting of water;
(c) porous voids surrounding at least a portion of said discrete templates, wherein said porous voids have an average pore length scale from about 50 nanometers to about 10 microns; and
(d) nanoparticles, dispersed uniformly within said matrix, that inhibit heterogeneous nucleation of water, wherein said nanoparticles have an average size of about 50 nanometers or less,
wherein said discrete templates and/or said nanoparticles include a surface material providing a surface hydrophobicity that decreases with increasing temperature.

2. The structural coating of claim 1, wherein said surface material has an upper critical solution temperature in water.

3. The structural coating of claim 2, wherein said upper critical solution temperature is about 10° C. or higher.

4. The structural coating of claim 3, wherein said upper critical solution temperature is about 50° C. or higher.

5. The structural coating of claim 1, wherein said surface hydrophobicity is characterized by a water contact angle that decreases by 30° or more over an increase in surface material temperature from 25° C. to 80° C.

6. The structural coating of claim 5, wherein said water contact angle decreases by 60° or more over said increase in said surface material temperature from 25° C. to 80° C.

7. The structural coating of claim 1, wherein said surface hydrophobicity is characterized by a water contact angle that decreases to 90° or lower over an increase in surface material temperature from 25° C. to 80° C.

8. The structural coating of claim 1, wherein said surface hydrophobicity is characterized by an average water contact angle decrease with temperature of at least 0.5 degrees per degree Celsius, when measured from 25° C. to 80° C.

9. The structural coating of claim 8, wherein said surface hydrophobicity is characterized by said average water contact angle decrease with temperature of at least 1.0 degrees per degree Celsius, when measured from 25° C. to 80° C.

10. The structural coating of claim 1, wherein said surface material comprises a polymer brush.

11. The structural coating of claim 10, wherein said polymer brush comprises poly[2-(methacryloyloxy)ethyl]dimethyl-(3-sulfopropyl)ammonium hydroxide.

12. The structural coating of claim 11, wherein said polymer brush comprises a co-polymer of at least 50 mol % of [2-(methacryloyloxy)ethyl]dimethyl-(3-sulfopropyl)ammonium hydroxide co-polymerized with another monomer.

13. The structural coating of claim 1, wherein said surface material comprises a physically adsorbed polymer layer.

14. The structural coating of claim 1, wherein said structural coating has a porosity from about 20% to about 70%.

15. The structural coating of claim 1, wherein said structural coating has a thickness from about 5 microns to about 500 microns.

16. The structural coating of claim 15, wherein said thickness of said structural coating is greater than 25 microns.

17. A coating precursor for a structural coating that inhibits wetting and freezing of water, said coating precursor comprising:
(a) a hardenable material capable of forming a substantially continuous matrix for a structural coating;
(b) discrete templates dispersed uniformly within said hardenable material, wherein said discrete templates have an average template length scale from about 50 nanometers to about 10 microns;
(c) porous voids surrounding at least a portion of said discrete templates, wherein said porous voids have an average pore length scale from about 50 nanometers to about 10 microns, and wherein said average pore length scale is less than said average template length scale; and
(d) nanoparticles dispersed uniformly within said hardenable material, wherein said nanoparticles have an average size of about 50 nanometers or less, and wherein said nanoparticles are chemically different than said discrete templates,
wherein said discrete templates and/or said nanoparticles include a surface material providing a surface hydrophobicity that decreases with increasing temperature.

18. The coating precursor of claim 17, wherein said surface material has an upper critical solution temperature in water of about 10° C. or higher.

19. The coating precursor of claim 18, wherein said upper critical solution temperature is about 50° C. or higher.

20. The coating precursor of claim 17, wherein said surface hydrophobicity is characterized by a water contact angle that decreases by 30° or more over an increase in surface material temperature from 25° C. to 80° C.

21. The coating precursor of claim 20, wherein said water contact angle decreases by 60° or more over said increase in said surface material temperature from 25° C. to 80° C.

22. The coating precursor of claim 17, wherein said surface hydrophobicity is characterized by a water contact angle that decreases to 90° or lower over an increase in surface material temperature from 25° C. to 80° C.

23. The coating precursor of claim 17, wherein said surface material comprises a polymer brush.

24. The coating precursor of claim 23, wherein said polymer brush comprises poly[2-(methacryloyloxy)ethyl]dimethyl-(3-sulfopropyl)ammonium hydroxide.

25. The coating precursor of claim 24, wherein said polymer brush comprises a co-polymer of at least 50 mol % of [2-(methacryloyloxy)ethyl]dimethyl-(3-sulfopropyl)ammonium hydroxide co-polymerized with another monomer.

26. A structural coating that inhibits wetting and freezing of water, said structural coating comprising a plurality of layers, wherein each layer is derived from a coating precursor; wherein said coating precursor comprises:
(a) a hardenable material capable of forming a substantially continuous matrix for a structural coating;
(b) discrete templates dispersed uniformly within said hardenable material, wherein said discrete templates have an average template length scale from about 50 nanometers to about 10 microns;
(c) porous voids surrounding at least a portion of said discrete templates, wherein said porous voids have an average pore length scale from about 50 nanometers to about 10 microns, and wherein said average pore length scale is less than said average template length scale; and
(d) nanoparticles dispersed uniformly within said hardenable material, wherein said nanoparticles have an average size of about 50 nanometers or less, and wherein said nanoparticles are chemically different than said discrete templates,
wherein said discrete templates and/or said nanoparticles include a surface material providing a surface hydrophobicity that decreases with increasing temperature.
